(19) United States
(12) Patent Application Publication
(10) Pub. No.: US 2026/0186589 A1
(43) Pub. Date: Jul. 2, 2026

(54) EASILY DETACHABLE TRANSPARENT FLEXIBLE TOUCH PAD HAVING SIMPLE STRUCTURE AND CONTROL METHOD THEREOF

(71) Applicant: Korea University of Technology and Education Industry-University Cooperation Foundation, Cheonan-si (KR)

(72) Inventors: Sang-Youn KIM, Seoul (KR); Seok Hun Lee, Cheonan-si (KR); Seok-Han Lee, Daejeon (KR)

(21) Appl. No.: 19/399,415

(22) Filed: Nov. 24, 2025

(30) Foreign Application Priority Data
Dec. 26, 2024 (KR) 10-2024-0196489

(51) Int. Cl. G06F 3/0354; G06F 3/041

(52) U.S. Cl. CPC G06F 3/03547; G06F 3/041; G06F 2203/04102; G06F 2203/04103

(57) ABSTRACT

Proposed is a transparent and flexible touch pad having a simple structure that can be easily attached and detached, and a control method thereof. The touch pad is composed of a substrate film having an electrode pattern formed thereon for touch detection of the transparent flexible touch pad, a functional adhesive formed by coating the substrate film having the electrode pattern formed thereon, so that the transparent flexible touch pad can be attached, detached, and reused, a controller for controlling touch detection of the electrode pattern, the controller electrically connected to the substrate film having the electrode pattern formed thereon for the touch detection of the transparent flexible touch pad, and a communication unit for transmitting a signal based on touch detection under control of the controller.

### CROSS-REFERENCE TO RELATED APPLICATION

The present application claims priority to Korean Patent Application No. 10-2024-0196489, filed on December 26, 2024, the entire contents of which are incorporated herein for all purposes by this reference.

### BACKGROUND

### TECHNICAL FIELD

The present disclosure relates to an easily detachable transparent flexible touch pad having a simple structure, and a control method thereof and, more specifically, to an easily detachable transparent flexible touch pad having a simple structure, and a control method thereof, wherein the pad can be attached to an upper surface of a display of a device that has no touch detection function or is damaged, to be used as a touch pad.

### DESCRIPTION OF THE RELATED ART

The contents described in this section are provided merely for background information on an exemplary embodiment of the present disclosure and do not constitute prior art.

In general, input devices such as a remote controller, keyboard, and mouse are essential for controlling devices such as televisions and computers, but there is a certain degree of disconnect with the display as these are external devices. Accordingly, devices such as smartphones and touch displays equipped with a touch sensor function enabling direct control on the display are used without the need for a separate external input device.

However, the devices equipped with these touch sensor functions are integrated into the display, so the display itself should be completely replaced when damaged, and a method like infrared sensing which operates separately from the display is expensive and has a structural drawback of substantially protruding outward.

In addition, there are cases where a separate transparent touch panel is attached and used, but the touch panel is composed of an upper protective material, an electrode pattern, a functional film such as a resistor or dielectric, and an external protective material, and requires a separate adhesive for attaching to the display, making it relatively thick and less transparent. Moreover, when an adhesive is used, it is completely attached to the display, and therefore it is difficult to remove and inconvenient to reattach for reuse. Korean Patent No. 10-2054934 is disclosed as a prior art document.

The above-described background technology is technical information that the inventor possessed for the purpose of deriving the present disclosure or acquired in the process of deriving the present disclosure, and therefore it cannot be necessarily regarded as prior art known or publicly disclosed to the general public prior to the application of the present disclosure.

### SUMMARY

The present disclosure is proposed to solve the above-described problems of the conventional methods, and an objective of the present disclosure is to provide an easily detachable transparent flexible touch pad having a simple structure and a control method thereof, wherein the pad can be attached to an upper surface of a display of a device that has no touch detection function or is damaged, to be used as a touch pad, by including a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern thereon for touch detection of the transparent flexible touch pad and a communication unit for transmitting a signal based on the touch detection under control of the controller.

In addition, another objective of the present disclosure is to provide an easily detachable transparent flexible touch pad having a simple structure and a control method thereof, wherein the pad is attached to an upper surface of a display of a device that has no touch detection function or is damaged to be used as a touch pad while allowing to be attached to and detached from the upper surface of the display by means of the functional adhesive, thereby further improving the efficiency and the convenience of the attachment, detachment, and reuse of the transparent flexible touch pad since it is relatively easy to attach and detach and leaves almost no residue compared to conventional adhesives while having sufficient adhesive strength as the adhesive.

Furthermore, by attaching for use to a display that has no touch function or is damaged, or a display where touch detection of a specific device is impossible to use, another objective of the present disclosure is to provide an easily detachable transparent flexible touch pad having a simple structure, and a control method thereof, wherein the pad can be universally applied to a display that has no touch detection function, is damaged, or is impossible to use, and can be utilized as a simple keyboard or as a medical sensor.

However, the technical tasks to be achieved by the present disclosure are not limited to those technical tasks described above, and other technical tasks may also exist.

The transparent flexible touch pad having a simple structure that can be easily attached and detached according to the features of the present disclosure for achieving the aforementioned objectives is an easily detachable transparent flexible touch pad having a simple structure, and includes a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern formed thereon for the touch detection of the transparent flexible touch pad, and a communication unit for transmitting a signal based on touch detection under control of the controller.

Preferably, the transparent flexible touch pad may be attached to an upper surface of a display that has no touch function or is damaged, or of a display where touch detection of a specific device is impossible, and may function as a touch pad for the touch detection.

Preferably, the substrate film may be composed of a flexible material such as PET, PP, a transparent polymer film, thin film glass, and thin film ceramic.

More preferably, the electrode pattern may be composed of a transparent carbon material, a transparent conductive ceramic, a nano metal particle or metal pattern, and a conductive polymer material.

Preferably, the functional adhesive may be composed of a mixture of an adhesive base material, a crosslinking agent for crosslinking the adhesive base material, a molecular weight regulator, a reaction initiator, and a functional additive so that the transparent flexible touch pad can be attached, detached, and reused.

Preferably, the communication unit may be configured with any one or a combination of two or more of Wi-Fi, Bluetooth, serial communication, and USB communication, for transmitting a signal based on touch detection under the control of the controller.

A method of controlling a transparent flexible touch pad having a simple structure that can be easily attached and detached according to the features of the present disclosure for achieving the aforementioned objectives is a method of controlling an easily detachable transparent flexible touch pad having a simple structure, and includes (1) attaching a functional adhesive to an upper surface of a display of a device having no touch detection function in the easily detachable transparent flexible touch pad having a simple structure which includes a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern formed thereon for the touch detection of the transparent flexible touch pad and a communication unit for transmitting a signal based on touch detection under control of the controller, (2) detecting and controlling, by the controller, a touch according to a touch of the substrate film having the electrode pattern formed thereon, and (3) transmitting, by the communication unit under the control of the controller, a control signal generated according to the touch detection to the device having no touch detection function.

Preferably, the transparent flexible touch pad may be attached to an upper surface of a display that has no touch function or is damaged, or of a display where touch detection of a specific device is impossible, and may function as a touch pad for the touch detection.

Preferably, the substrate film may be composed of a flexible material such as PET, PP, a transparent polymer film, thin film glass, and thin film ceramic.

More preferably, the electrode pattern may be composed of a transparent carbon material, a transparent conductive ceramic, a nano metal particle or metal pattern, and a conductive polymer material.

Preferably, the functional adhesive may be composed of a mixture of an adhesive base material, a crosslinking agent for crosslinking the adhesive base material, a molecular weight regulator, a reaction initiator, and a functional additive so that the transparent flexible touch pad can be attached, detached, and reused.

According to the easily detachable transparent flexible touch pad having a simple structure and the control method thereof proposed by the present disclosure, it is possible to be attached to an upper surface of a display of a device that has no touch detection function or is damaged, to be used as a touch pad, by including a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern thereon for touch detection of the transparent flexible touch pad and a communication unit for transmitting a signal based on the touch detection under control of the controller.

In addition, according to the easily detachable transparent flexible touch pad having a simple structure and the control method thereof proposed by the present disclosure, it is possible to be attached to an upper surface of a display of a device that has no touch detection function or is damaged to be used as a touch pad while allowing to be attached to and detached from the upper surface of the display by means of the functional adhesive, thereby further improving the efficiency and the convenience of the attachment, detachment, and reuse of the transparent flexible touch pad since it is relatively easy to attach and detach and leaves almost no residue compared to conventional adhesives while having sufficient adhesive strength as the adhesive.

Furthermore, according to the easily detachable transparent flexible touch pad having a simple structure and the control method thereof proposed by the present disclosure, by attaching for use to a display that has no touch function or is damaged, or a display where touch detection of a specific device is impossible to use, it is possible not only to be universally applied to a display that has no touch detection function, is damaged, or is impossible to use, but also to be utilized as a simple keyboard or as a medical sensor.

Furthermore, the diverse and beneficial advantages and effects of the present disclosure may not be limited to the aforementioned content, and will become more readily apparent in the course of describing the specific exemplary embodiments of the present disclosure.

### BRIEF DESCRIPTION OF THE DRAWINGS

FIG. 1 is a view illustrating, as a functional block, a configuration of an easily detachable transparent flexible touch pad having a simple structure according to an exemplary embodiment of the present disclosure.

FIG. 2 is a view illustrating a material configuration of a substrate film of an easily detachable transparent flexible touch pad having a simple structure according to an exemplary embodiment of the present disclosure.

FIG. 3 is a view illustrating a material configuration of an electrode pattern of an easily detachable transparent flexible touch pad having a simple structure according to an exemplary embodiment of the present disclosure.

FIG. 4 is a view illustrating a configuration of a communication unit of an easily detachable transparent flexible touch pad having a simple structure according to an exemplary embodiment of the present disclosure.

FIG. 5 is a view illustrating a schematic configuration of an easily detachable transparent flexible touch pad having a simple structure according to an exemplary embodiment of the present disclosure.

FIG. 6 is a view illustrating a process for attaching an easily detachable transparent flexible touch pad having a simple structure to a display of a device having no touch detection function according to an exemplary embodiment of the present disclosure.

FIG. 7 is a view illustrating a configuration of a portable device having a damaged touch function, in which an easily detachable transparent flexible touch pad having a simple structure is to be used according to an exemplary embodiment of the present disclosure.

FIG. 8 is a view illustrating a configuration before attaching a transparent flexible touch pad for attaching to a portable device having a damaged touch function, as an easily detachable transparent flexible touch pad having a simple structure according to an exemplary embodiment of the present disclosure.

FIG. 9 is a view illustrating a configuration when an easily detachable transparent flexible touch pad having a simple structure according to an exemplary embodiment of the present disclosure is attached to a portable device having a damaged touch function.

FIG. 10 is a view illustrating a configuration of an example in which an easily detachable transparent flexible touch pad having a simple structure according to an exemplary embodiment of the present disclosure is implemented as a simple keyboard.

FIG. 11 is a view illustrating a configuration of an example in which an easily detachable transparent flexible touch pad having a simple structure according to an exemplary embodiment of the present disclosure is implemented as a medical sensor.

FIG. 12 is a view illustrating a flow of a control method of an easily detachable transparent flexible touch pad having a simple structure according to an exemplary embodiment of the present disclosure.

### DETAILED DESCRIPTION OF THE DISCLOSURE

Hereinafter, exemplary embodiments of the present disclosure will be described in detail with reference to the attached drawings so that those skilled in the art can easily practice the present disclosure. However, the present disclosure may be implemented in various forms and is not limited to the exemplary embodiments described herein. In addition, in order to clearly explain the present disclosure in the drawings, parts irrelevant to the description may be omitted, and similar parts may be designated with similar drawing reference numerals throughout the specification.

Throughout the specification, when a certain part is "connected" to another part, it may include not only "directly connected," but also "indirectly connected" with another element interposed therebetween. In addition, when a certain part "includes" a particular component, unless specifically stated otherwise, it may include other components rather than excluding other components, and it should be understood that the presence or addition of one or more other features, numbers, steps, operations, elements, parts, or combinations thereof is not precluded in advance.

The following examples may be detailed descriptions for helping the understanding of the present disclosure and may not limit the scope of the present disclosure. Therefore, inventions of the same scope performing the same function as the present disclosure will also fall within the scope of the present disclosure.

In addition, each configuration, process, procedure or method included in each exemplary embodiment of the present disclosure may be shared with one another, as long as those are not technically inconsistent with each other.

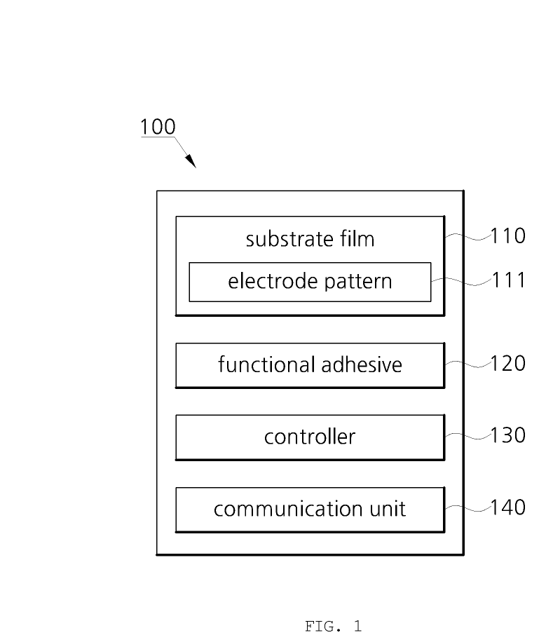

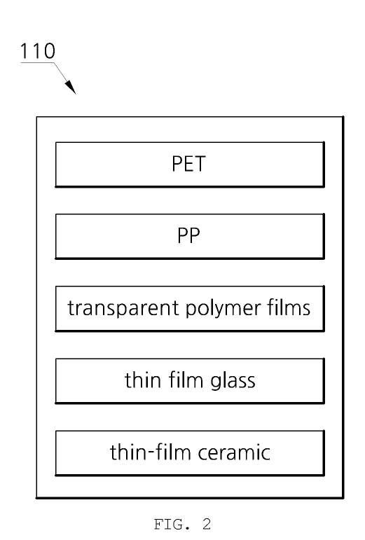

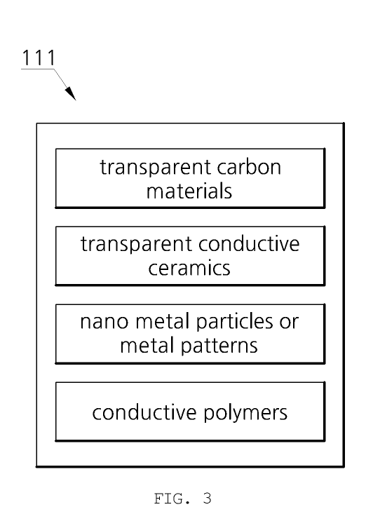

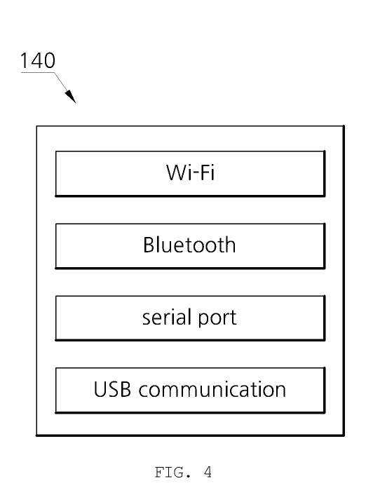

FIG. 1 is a view illustrating, as a functional block, a configuration of an easily detachable transparent flexible touch pad having a simple structure according to an exemplary embodiment of the present disclosure, FIG. 2 is a view illustrating a material configuration of a substrate film of an easily detachable transparent flexible touch pad having a simple structure according to an exemplary embodiment of the present disclosure, FIG. 3 is a view illustrating a material configuration of an electrode pattern of an easily detachable transparent flexible touch pad having a simple structure according to an exemplary embodiment of the present disclosure, and FIG. 4 is a view illustrating a configuration of a communication unit of an easily detachable transparent flexible touch pad having a simple structure according to an exemplary embodiment of the present disclosure. As shown in FIGS. 1 to 4, an easily detachable transparent flexible touch pad having a simple structure 100 according to an exemplary embodiment of the present disclosure may include a substrate film 110 having an electrode pattern 111 formed thereon for touch detection of the transparent flexible touch pad 100, a functional adhesive 120 formed by coating the substrate film 110 having the electrode pattern 111 formed thereon so that the transparent flexible touch pad 100 can be attached, detached, and reused, a controller 130 for controlling touch detection of the electrode pattern 111, which is electrically connected to the substrate film 110 having the electrode pattern 111 formed thereon for touch detection of the transparent flexible touch pad 100, and a communication unit 140 for transmitting a signal based on touch detection under the control of the controller 130. Hereinafter, a detailed configuration of a transparent flexible touch pad having a simple structure that can be easily attached and detached according to an exemplary embodiment of the present disclosure will be described in detail with reference to the accompanying drawings.

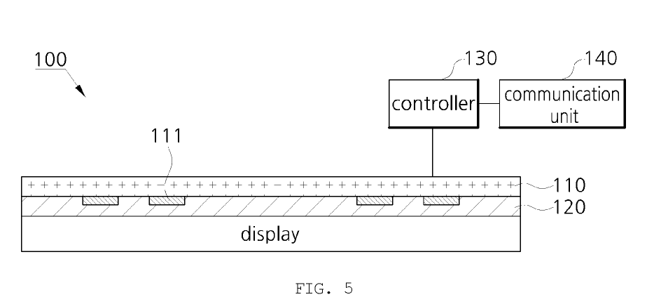

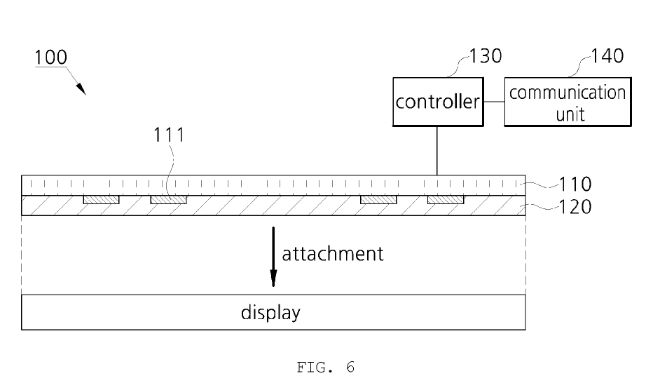

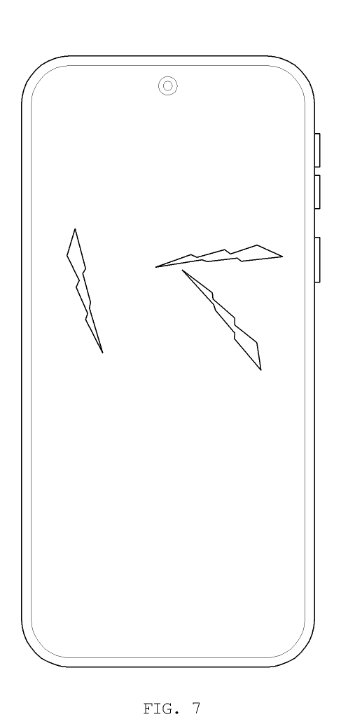

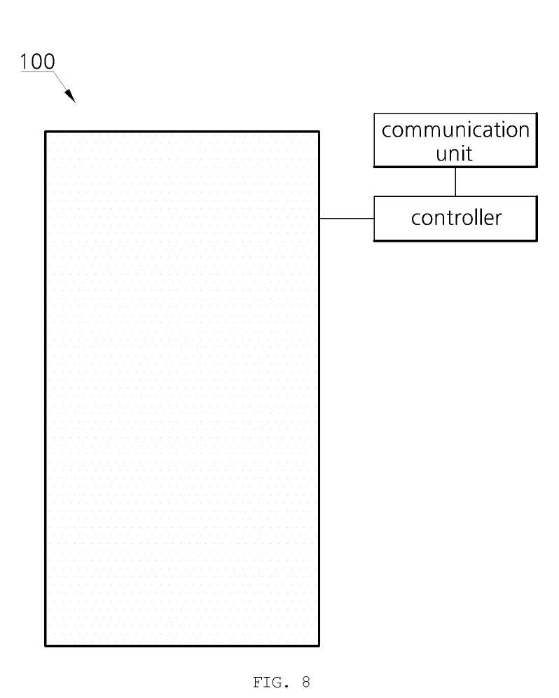

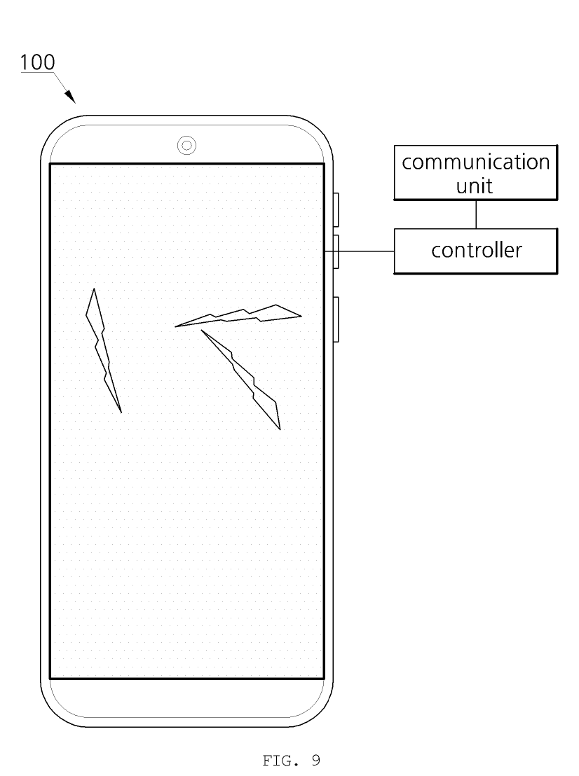

FIG. 5 is a view illustrating a schematic configuration of an easily detachable transparent flexible touch pad having a simple structure according to an exemplary embodiment of the present disclosure, FIG. 6 is a view illustrating a process for attaching an easily detachable transparent flexible touch pad having a simple structure to a display of a device having no touch detection function according to an exemplary embodiment of the present disclosure, FIG. 7 is a view illustrating a configuration of a portable device having a damaged touch function, in which an easily detachable transparent flexible touch pad having a simple structure is to be used according to an exemplary embodiment of the present disclosure, FIG. 8 is a view illustrating a configuration before attaching a transparent flexible touch pad for attaching to a portable device having a damaged touch function, as an easily detachable transparent flexible touch pad having a simple structure according to an exemplary embodiment of the present disclosure, and FIG. 9 is a view illustrating a configuration when an easily detachable transparent flexible touch pad having a simple structure according to an exemplary embodiment of the present disclosure is attached to a portable device having a damaged touch function.

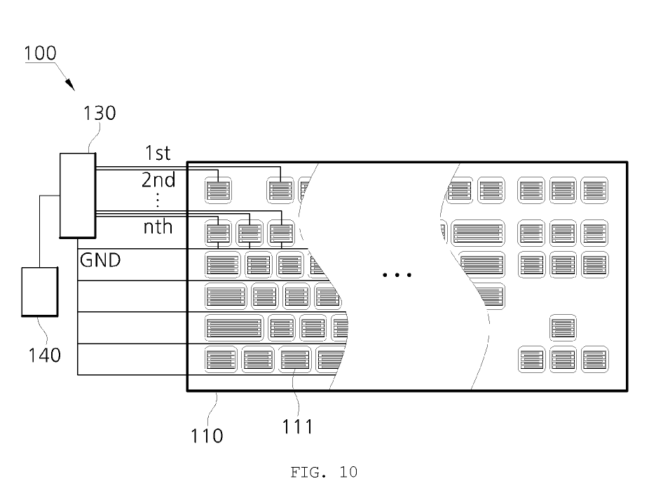

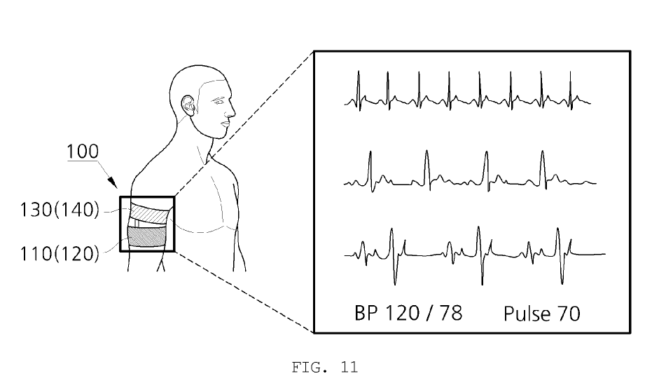

In addition, FIG. 10 is a view illustrating a configuration of an example in which an easily detachable transparent flexible touch pad having a simple structure according to an exemplary embodiment of the present disclosure is implemented as a simple keyboard, and FIG. 11 is a view illustrating a configuration of an example in which an easily detachable transparent flexible touch pad having a simple structure according to an exemplary embodiment of the present disclosure is implemented as a medical sensor.

The substrate film 110 may be a configuration in which an electrode pattern 111 is formed for touch detection in the transparent flexible touch pad 100. As illustrated in FIG. 2, the substrate film 110 may be composed of a flexible material such as PET, PP, a transparent polymer film, thin film glass, and thin film ceramic. Herein, in addition to flexible materials such as PET, PP, a transparent polymer film, thin film glass, and thin film ceramic, the substrate film 110 may employ a non-flexible thick polymer film, glass, or ceramic, as needed and in some cases and may be configured to be opaque through coating, dyeing, color mixing, or inherent opacity, as needed and in some cases.

In addition, the electrode pattern 111 may be composed of a transparent carbon material, a transparent conductive ceramic, nano metal particles or metal patterns, and a conductive polymer material. Herein, the electrode pattern 111 may use various materials, and a non-transparent electrode may be used as needed and in some cases.

The functional adhesive 120 may be configured to be formed by coating the substrate film 110 having the electrode pattern 111 formed thereon, so that the transparent flexible touch pad 100 can be attached, detached, and reused. The functional adhesive 120 may be composed of a mixture of an adhesive base material, a crosslinking agent for crosslinking the adhesive base material, a molecular weight regulator, a reaction initiator, and a functional additive so that the transparent flexible touch pad can be attached, detached, and reused. The types of the adhesive base material may include acrylic polymers, silicone polymers, acrylates, ester rubbers, phenol resins, and other adhesives.

In addition, the types of crosslinking agents for the functional adhesive 120 may include all crosslinking agents used in adhesives, such as isocyanate-based and epoxy-based adhesives, and it may also be understood that the molecular weight regulator and reaction initiator include all types used in adhesives.

In addition, the functional additive of the functional adhesive 120 may include an organic or inorganic dielectric material, a carbon material (graphene, graphite, fluorocarbon, carbon nanotube), an organic or inorganic conductive material and, furthermore, the functional additive may include other functional materials such as magneto-responsive materials and thermoelectric materials for special purposes such as magnetic reactivity, thermal reactivity, heating, and cooling.

Such a functional adhesive 120 may be relatively easy to attach and detach and may leave almost no residue, unlike conventional adhesives, while having sufficient adhesive strength, thereby providing the advantage of relatively easy attachment and detachment. Furthermore, the material of the functional adhesive 120 may be suitable as a sensor material because it is transparent and has high dielectric properties like a low-molecular acrylic polymer, a silicone polymer, an acylate, an ester rubber, or a phenol resin or has high similarity in composition to the material of the electroactive polymer. In addition, dielectric or conductivity can be improved by mixing organic or inorganic dielectric fillers, conductive fillers, etc., thereby functioning to improve performance with the sensor material of a capacitive type or a piezoresistive type. Moreover, techniques for coating films with adhesives such as gravure coating and die casting may already be well commercialized, and it is possible to coat inexpensive substrates such as PET and PP with the adhesives at low cost and it is possible to function to be used as a detachable, transparent and inexpensive touch pad when coating the substrate film 110 having an electrode pattern 111 formed thereon.

The controller 130 may be configured to be electrically connected to the substrate film 110 having an electrode pattern 111 formed thereon for touch detection of the transparent flexible touch pad 100 and to control touch detection of the electrode pattern 111. The controller 130 may be applied to all types utilized in general touch pads or capacitive and resistive touch pads.

The communication unit 140 may be configured to transmit a signal based on touch detection under the control of the controller 130. As illustrated in FIG. 4, the communication unit 140 may be configured with one or a combination of two or more of Wi-Fi, Bluetooth, serial communication, and USB communication for transmitting a signal based on touch detection under the control of the controller 130. Herein, it may be understood that the communication unit 140 includes all types of communication methods such as Wi-Fi, Bluetooth, serial port, USB communication, and the like.

FIG. 7 is a view illustrating a configuration of a portable device having a damaged touch function, in which an easily detachable transparent flexible touch pad having a simple structure is to be used according to an exemplary embodiment of the present disclosure, FIG. 8 is a view illustrating a configuration before attaching a transparent flexible touch pad for attaching to a portable device having a damaged touch function, as an easily detachable transparent flexible touch pad having a simple structure according to an exemplary embodiment of the present disclosure, and FIG. 9 is a view illustrating a configuration when an easily detachable transparent flexible touch pad having a simple structure according to an exemplary embodiment of the present disclosure is attached to a portable device having a damaged touch function. FIGS. 7 to 9 illustrate a process for attaching the transparent touch pad to a portable display, and illustrate a configuration of an example in which the transparent flexible touch pad 100 is attached to and used on a display of a portable device whose touch function is damaged.

In addition, FIG. 10 is a view illustrating a configuration of an example in which an easily detachable transparent flexible touch pad having a simple structure according to an exemplary embodiment of the present disclosure is implemented as a simple keyboard, and FIG. 11 is a view illustrating a configuration of an example in which an easily detachable transparent flexible touch pad having a simple structure according to an exemplary embodiment of the present disclosure is implemented as a medical sensor. FIG. 10 illustrates a portable keyboard form, which can be implemented as a keyboard that can be folded or rolled up for everyday carrying, attached to a flat surface or floor when needed, and retrieved after use. FIG. 11 illustrates a medical sensor form, which can be implemented as a medical sensor that can be easily attached to collect and retrieve bodily signals such as pulse and blood pressure.

In this way, an easily detachable transparent flexible touch pad having a simple structure 100 which includes the substrate film 110 having the electrode pattern 111 formed thereon for touch detection of the transparent flexible touch pad 100, the functional adhesive 120 formed by coating the substrate film 110 having the electrode pattern 111 formed thereon so that the transparent flexible touch pad 100 can be attached, detached, and reused, the controller 130 for controlling the touch detection of the electrode pattern 111, which is electrically connected to the substrate film 110 having the electrode pattern 111 formed thereon for touch detection of the transparent flexible touch pad 100, a communication unit 140 for transmitting a signal based on touch detection under the control of the controller 130, can be attached to the upper surface of a display of a device that does not have a touch detection function or is damaged, or of a display where touch detection of a specific device is not possible, thereby functioning as a touch pad for touch detection. That is, the transparent flexible touch pad 100 may be a detachable and reusable touch pad for the basic purpose of utilizing as a touch pad, and may be implemented to serve as a damage detection sensor or a medical sensor as needed. In addition, the transparent flexible touch pad 100 may be opaque depending on the need and material, and may also be configured in a hard form.

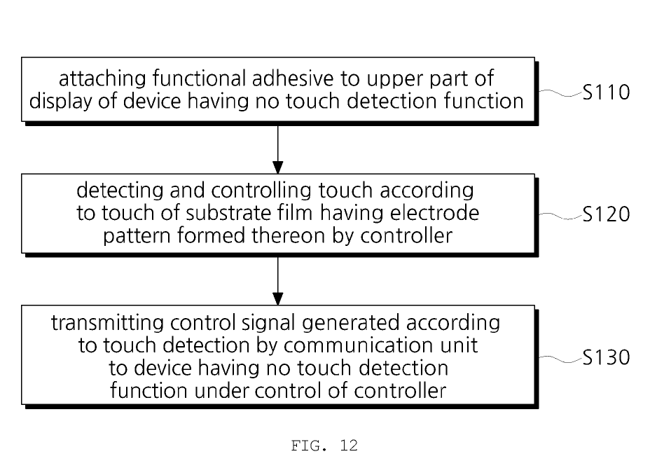

FIG. 12 is a view illustrating a flow of a control method of an easily detachable transparent flexible touch pad having a simple structure according to an exemplary embodiment of the present disclosure. As illustrated in FIG. 12, the control method of the easily detachable transparent flexible touch pad having a simple structure according to an exemplary embodiment of the present disclosure may be implemented by including attaching a functional adhesive to an upper surface of a display of a device having no touch detection function (S110), detecting and controlling, by a controller, a touch according to a touch of a substrate film having an electrode pattern formed thereon (S120), and transmitting, by the communication unit, a control signal generated according to touch detection to a device having no touch detection function under the control of the controller (S130).

In step S110, the functional adhesive 120 may be attached to the upper surface of the display of the device having no touch detection function in the easily detachable transparent and flexible touch pad 100 having a simple structure which includes a substrate film 110 having an electrode pattern 111 formed thereon for touch detection of the transparent and flexible touch pad 100, a functional adhesive 120 formed by coating the substrate film 110 having the electrode pattern 111 formed thereon so that the transparent flexible touch pad 100 can be attached, detached, and reused, a controller 130 for controlling touch detection of the electrode pattern 111, which is electrically connected to the substrate film 110 having the electrode pattern 111 formed thereon for touch detection of the transparent and flexible touch pad 100, and a communication unit 140 for transmitting a signal based on touch detection under the control of the controller 130. As illustrated in FIG. 2, the substrate film 110 in step S110 may be composed of a flexible material such as PET, PP, a transparent polymer film, thin film glass, and thin film ceramic. In addition to flexible material such as PET, PP, a transparent polymer film, thin film glass, and thin film ceramic, the substrate film 110 may employ a non-flexible thick polymer film, glass, or ceramic, as needed and in some cases, and may be configured to be opaque through coating, dyeing, color mixing, or inherent opacity, as needed and in some cases.

In addition, the electrode pattern 111 may be composed of a transparent carbon material, a transparent conductive ceramic, nano metal particles or metal patterns, and a conductive polymer material. Herein, the electrode pattern 111 may use various materials, and a non-transparent electrode may be used as needed and in some cases.

In addition, the functional adhesive in step 110 may be composed of a mixture of an adhesive base material, a crosslinking agent for crosslinking the adhesive base material, a molecular weight regulator, a reaction initiator, and a functional additive so that the transparent flexible touch pad can be attached, detached, and reused. Herein, the types of the adhesive base material may include acrylic polymers, silicone polymers, acrylates, ester rubbers, phenol resins, and other adhesives.

In addition, the types of crosslinking agents for the functional adhesive 120 in step 110 may include all crosslinking agents used in adhesives, such as isocyanate-based and epoxy-based adhesives, and it may also be understood that the molecular weight regulator and reaction initiator include all types used in adhesives.

In addition, the functional additive of the functional adhesive 120 may include an organic or inorganic dielectric material, a carbon material (graphene, graphite, fluorocarbon, carbon nanotube), an organic or inorganic conductive material and, furthermore, the functional additive may include other functional materials such as magneto-responsive materials and thermoelectric materials for special purposes such as magnetic reactivity, thermal reactivity, heating, and cooling.

Such a functional adhesive 120 may be relatively easy to detach and leave almost no residue, unlike conventional adhesives, while having sufficient adhesive strength, thereby providing the advantage of relatively easy attachment and detachment. Furthermore, the material of the functional adhesive 120 may be suitable as a sensor material because it is transparent and has high dielectric properties like a low-molecular acrylic polymer, a silicone polymer, an acylate, an ester rubber, or a phenol resin or has high similarity in composition to the material of the electroactive polymer. In addition, dielectric or conductivity can be improved by mixing organic or inorganic dielectric fillers, conductive fillers, etc., thereby functioning to improve performance with a sensor material of a capacitive type or a piezoresistive type. Moreover, techniques of coating films with adhesives such as gravure coating and die casting may already be well commercialized, and it is possible to coat inexpensive substrates such as PET and PP with the adhesives at low cost and it is possible to function to be used as an easily detachable transparent and inexpensive touch pad having a simple structure when coating the substrate film 110 having an electrode pattern 111 formed thereon.

In step S120, the controller 130 may detect and control a touch according to the touch of the substrate film 110 having the electrode pattern 111 formed thereon. The controller 130 in step S120 may be applied to all types used in a general touch pad or a capacitive and resistive touch pad.

In step S130, the communication unit 140 may transmit a control signal generated in response to the touch detection to a device having no touch detection function under the control of the controller 130. As illustrated in FIG. 4, the communication unit 140 in step S130 may be configured with one or a combination of two or more of Wi-Fi, Bluetooth, serial communication, and USB communication for transmitting a signal based on the touch detection under the control of the controller 130. Herein, it may be understood that the communication unit 140 includes all types of communication methods such as Wi-Fi, Bluetooth, serial port, USB communication, and the like.

As described above, an easily detachable transparent flexible touch pad having a simple structure and a control method thereof can be attached to an upper surface of a display of a device that has no touch detection function or is damaged, to be used as a touch pad, by including a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern thereon for touch detection of the transparent flexible touch pad and a communication unit for transmitting a signal based on the touch detection under control of the controller, especially can be attached to an upper surface of a display of a device that has no touch detection function or is damaged to be used as a touch pad while allowing to be attached to and detached from the upper surface of the display by means of the functional adhesive, thereby further improving the efficiency and the convenience of the attachment, detachment, and reuse of the transparent flexible touch pad since it is relatively easy to attach and detach and leaves almost no residue compared to conventional adhesives while having sufficient adhesive strength as the adhesive, and also by attaching for use to a display that has no touch function or is damaged, or a display where touch detection of a specific device is impossible to use, can be universally applied to a display that has no touch detection function, is damaged, or is impossible to use and can be utilized as a simple keyboard or as a medical sensor.

The foregoing description of the present disclosure may be for illustrative purposes only, and those skilled in the art to which the present disclosure pertains will readily understand that it can be easily transformed into other specific forms without changing the technical idea or essential features of the present disclosure. Therefore, it should be understood that the exemplary embodiments described above are exemplary in all respects and not restrictive. For example, each component described in a single form may be implemented in a distributed manner, and similarly, components described as distributed may be implemented in a combined form.

The scope of the present disclosure may be indicated by the claims described below rather than the detailed description above, and all changes or modifications derived from the meaning and scope of the claims and their equivalent concepts should be interpreted as being included in the scope of the present disclosure.

What is claimed is:

1. An easily detachable transparent flexible touch pad having a simple structure, the pad comprising:
a substrate film having an electrode pattern formed thereon for touch detection of the transparent flexible touch pad;
a functional adhesive formed by coating the substrate film having the electrode pattern formed thereon, the functional adhesive for allowing attachment, detachment, and reuse of the transparent flexible touch pad;
a controller for controlling touch detection of the electrode pattern, the controller electrically connected to the substrate film having the electrode pattern formed thereon for the touch detection of the transparent flexible touch pad; and
a communication unit for transmitting a signal based on touch detection under control of the controller.

2. The pad of claim 1, wherein the transparent flexible touch pad is attached to an upper surface of a display that has no touch function or is damaged, or of a display where touch detection of a specific device is impossible, and functions as a touch pad for the touch detection.

3. The pad of claim 1, wherein the substrate film is composed of a flexible material such as PET, PP, a transparent polymer film, thin film glass, and thin film ceramic.

4. The pad of claim 3, wherein the electrode pattern is composed of a transparent carbon material, a transparent conductive ceramic, a nano metal particle or metal pattern, and a conductive polymer material.

5. The pad of claim 1, wherein the functional adhesive is composed of a mixture of an adhesive base material, a crosslinking agent for crosslinking the adhesive base material, a molecular weight regulator, a reaction initiator, and a functional additive so that the transparent flexible touch pad can be attached, detached, and reused.

6. The pad of claim 1, wherein the communication unit is configured with anyone or a combination of two or more of Wi-Fi, Bluetooth, serial communication, and USB communication, for transmitting a signal based on touch detection under the control of the controller.

7. A method of controlling an easily detachable transparent flexible touch pad having a simple structure, the method comprising:
(1) attaching a functional adhesive to an upper surface of a display of a device having no touch detection function in the easily detachable transparent flexible touch pad having a simple structure which includes a substrate film having an electrode pattern formed thereon for touch detection of the transparent flexible touch pad, a functional adhesive formed by coating the substrate film having the electrode pattern formed thereon, the functional adhesive for allowing attachment, detachment, and reuse of the transparent flexible touch pad, a controller for controlling touch detection of the electrode pattern, the controller electrically connected to the substrate film having the electrode pattern formed thereon for the touch detection of the transparent flexible touch pad and a communication unit for transmitting a signal based on touch detection under control of the controller;
(2) detecting and controlling, by the controller, a touch according to a touch of the substrate film having the electrode pattern formed thereon; and
(3) transmitting, by the communication unit under the control of the controller, a control signal generated according to the touch detection to the device having no touch detection function.

8. The method of claim 7, wherein the transparent flexible touch pad is attached to an upper surface of a display that has no touch function or is damaged, or of a display where touch detection of a specific device is impossible, and functions as a touch pad for the touch detection.
